(19) United States
(12) Patent Application Publication
(10) Pub. No.: US 2020/0145403 A1
(43) Pub. Date: May 7, 2020

(54) AUTHENTICATION SYSTEM AND AUTHENTICATION METHOD

(71) Applicant: VIVOTEK INC., New Taipei City (TW)

(72) Inventors: Hung-Chih Chang, New Taipei City (TW); Mu-Jen Ting, New Taipei City (TW); Po-Shen Chiu, New Taipei City (TW)

(21) Appl. No.: 16/669,528

(22) Filed: Oct. 31, 2019

(30) Foreign Application Priority Data
Nov. 5, 2018 (TW) 107139100

(51) Int. Cl. H04L 29/06; G06F 21/62; G06F 21/78; G06F 21/33

(52) U.S. Cl. CPC H04L 63/0807; G06F 21/6209; G06F 21/335; G06F 21/78; G06F 21/6218

(57) ABSTRACT

An authentication system includes a storage device, an authentication server, a work server, and a user device. The authentication server communicates with the storage device. The work server communicates with the authentication server. The user device communicates with the authentication server and the work server. The user device logins in the authentication server and obtains an authentication token from the authentication server. The authentication server obtains an information from the storage device and transmits the information to the work server. The user device transmits the authentication token to the authentication server through the work server to perform authentication. The work server obtains an authentication result from the authentication server. When the authentication result is correct, the work server performs an operation request of the user device for the information.

### BACKGROUND OF THE INVENTION

### 1. Field of the Invention

The invention relates to an authentication system and an authentication method and, more particularly, to an authentication system and an authentication method performing authentication for a user device through an authentication server.

### 2. Description of the Prior Art

A work server is used to serve various user devices (e.g. computer, smart phone, etc.) in a network system. In general, the work server communicates with a storage device, such that the work server may access information from the storage device according to a remote request. Most storage devices cannot limit authorization according to login users of applications. That is to say, when the work server is performing a remote request, the work server usually has full access right of the storage device. Therefore, once the work server is invaded, all information of the storage device will be leaked out to cause a serious disaster.

### SUMMARY OF THE INVENTION

An objective of the invention is to provide an authentication system and an authentication method performing authentication for a user device through an authentication server, so as to solve the aforesaid problems.

According to an embodiment of the invention, an authentication system comprises a storage device, an authentication server, a work server and a user device. The authentication server communicates with the storage device. The work server communicates with the authentication server. The user device communicates with the authentication server and the work server. The user device logins in the authentication server and obtains an authentication token from the authentication server. The authentication server obtains an information from the storage device and transmits the information to the work server. The user device transmits the authentication token to the authentication server through the work server to perform authentication. The work server obtains an authentication result from the authentication server. The work server performs an operation request of the user device for the information when the authentication result is correct.

According to another embodiment of the invention, an authentication method comprises steps of logining in an authentication server to obtain an authentication token; obtaining an information from a storage device and transmitting the information to a work server; transmitting the authentication token to the authentication server through the work server to perform authentication, so as to obtain an authentication result; and performing an operation request for the information when the authentication result is correct.

As mentioned in the above, the invention performs authentication for the user device through the authentication server with the authentication token and obtains the information requested by the user device from the storage device through the authentication server. When the work server obtains a correct authentication result from the authentication server, the work server performs the operation request of the user device accordingly. On the other hand, when the work server obtains an incorrect authentication result from the authentication server, the work server does not perform the operation request of the user device accordingly. The invention accesses the storage device through the authentication server and the work server does not have access right of the storage device. Accordingly, once the work server is invaded, except the information of the work server, other information of the storage device will not be leaked out.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an authentication system according to an embodiment of the invention.

FIG. 2 is a flowchart illustrating an authentication method according to an embodiment of the invention.

FIG. 3 is a time sequence diagram illustrating an authentication method according to an embodiment of the invention.

FIG. 4 is a time sequence diagram illustrating an authentication method according to another embodiment of the invention.

FIG. 5 is a time sequence diagram illustrating an authentication method according to another embodiment of the invention.

### DETAILED DESCRIPTION

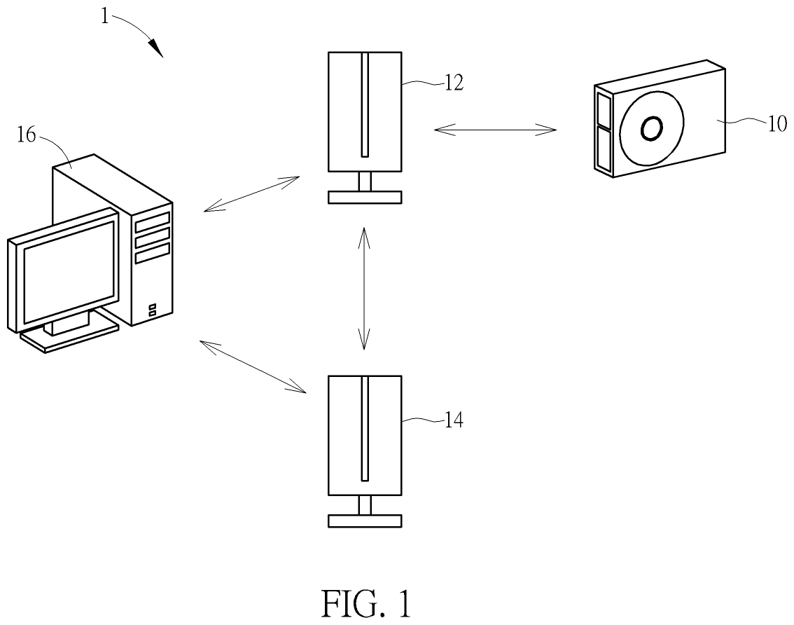

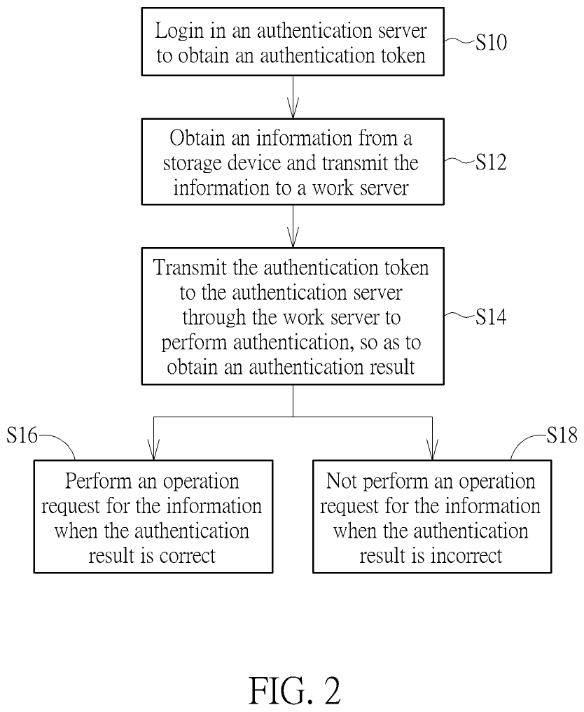

Referring to FIGS. 1 and 2, FIG. 1 is a schematic diagram illustrating an authentication system 1 according to an embodiment of the invention and FIG. 2 is a flowchart illustrating an authentication method according to an embodiment of the invention. The authentication method shown in FIG. 2 may be implemented by the authentication system 1 shown in FIG. 1.

As shown in FIG. 1, the authentication system 1 comprises a storage device 10, an authentication server 12, a work server 14 and a user device 16, wherein the authentication server 12 communicates with the storage device 10, the work server 14 communicates with the authentication server 12, and the user device 16 communicates with the authentication server 12 and the work server 14. In practical applications, the storage device 10 may a network attached storage (NAS), a hard disk server or other data storage devices, and the user device 16 may be a computer, a smart phone or other user devices.

In this embodiment, a user may operate the user device 16 to login in the authentication server 12 by a login identification and a password and then obtain an authentication token from the authentication server 12 (step S10 in FIG. 2). In this embodiment, the authentication server 12 may stores a plurality of login identifications of different users and a plurality of access rights correspondingly. After the authentication server 12 authenticate that the login identification and the password of the user device are correct, the authentication server 12 obtains an information requested by the user device 16 from the storage device 10 according to the login identification of the user device 16 and then transmits the information to the work server 14 (step S14 in FIG. 2). The aforesaid information may be a device list or a file.

Then, the user device 16 transmits the authentication token to the authentication server 12 through the work server 14 to perform authentication. In this embodiment, the user device 16 transmits the authentication token to the work server 14 first and then the work server 14 transmits the authentication token to the authentication server 12 to perform authentication (step S14 in FIG. 2). Then, the work server 14 obtains an authentication result from the authentication server 12 (step S14 in FIG. 2). In this embodiment, the authentication server 12 authenticates whether the authentication token transmitted from the work server 14 is identical to the authentication toke obtained by the user device 16 from the authentication server 12. When the authentication token transmitted from the work server 14 is identical to the authentication toke obtained by the user device 16 from the authentication server 12, the authentication result is correct. On the other hand, when the authentication token transmitted from the work server 14 is different from the authentication toke obtained by the user device 16 from the authentication server 12, the authentication result is incorrect.

When the authentication result is correct, the work server 14 performs an operation request of the user device 16 for the aforesaid information (step S16 in FIG. 2), wherein the operation request is inputted and transmitted to the work server 14 by the user operating the user device 16. On the other hand, when the authentication result is incorrect, the work server 14 does not perform the operation request of the user device 16 for the aforesaid information (step S18 in FIG. 2).

In this embodiment, if the work server 14 is coupled to a plurality of cameras, the aforesaid information may be a device list recording names and passwords of the cameras and the aforesaid operation request may be to perform a specific operation fora specific camera (e.g. to watch a monitored image, to adjust a monitored range, etc.). In another embodiment, the aforesaid information may be a specific file and the aforesaid operation request may be to perform a specific operation for the specific file (e.g. to perform encryption, modification, etc.).

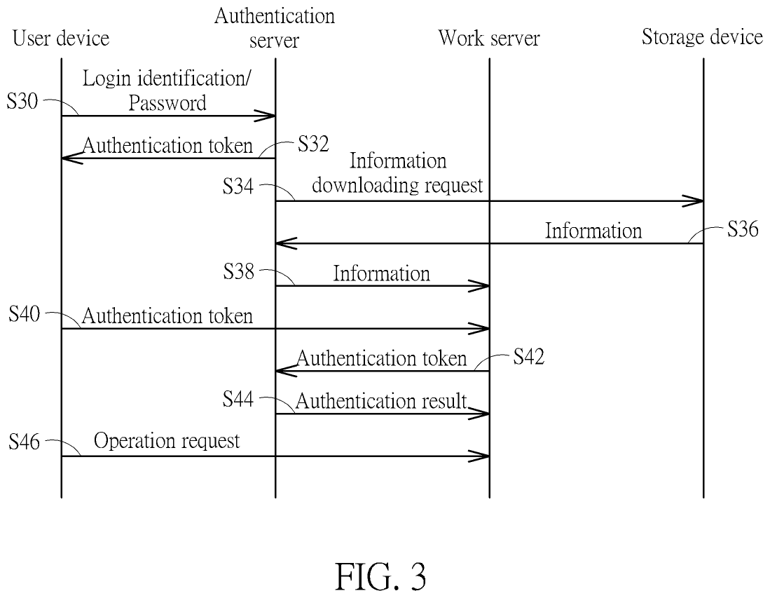

Referring to FIG. 3, FIG. 3 is a time sequence diagram illustrating an authentication method according to an embodiment of the invention. The authentication method shown in FIG. 3 may be implemented by the authentication system 1 shown in FIG. 1. As shown in FIG. 3, first, the user device 16 logins in the authentication server 12 by a login identification and a password (step S30). After the user device 16 logins in the authentication server 12, the user device 16 obtains an authentication token from the authentication server 12 (step S32). After the authentication server 12 authenticates that the login identification and the password of the user device 16 are correct, the authentication server 12 transmits an information downloading request to the storage device 10 according to the login identification of the user device 16 (step S34), so as to obtain an information requested by the user device 16 from the storage device (step S36). Then, the authentication server 12 transmits the information to the work server 14 (step S38). After the user device 16 obtains the authentication token from the authentication server 12, the user device 16 transmits the authentication token to the work server 14 (step S40). Then, the work server 14 transmits the authentication token to the authentication server 12 to perform authentication (step S42). Then, the work server 14 obtains an authentication result from the authentication server 12 (step S44). Then, a user may operate the user device 16 to input and transmit an operation request to the work server 14 (step S46). When the authentication result is correct, the work server 14 performs the operation request of the user device 16 for the aforesaid information. On the other hand, when the authentication result is incorrect, the work server 14 does not perform the operation request of the user device 16 for the aforesaid information. It should be noted that the manner of authenticating the authentication token is mentioned in the above and that will not be depicted herein again.

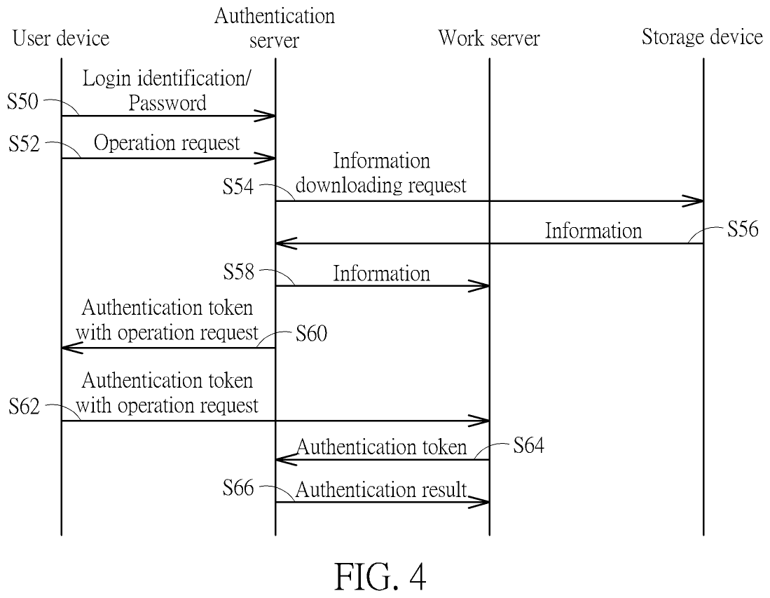

Referring to FIG. 4, FIG. 4 is a time sequence diagram illustrating an authentication method according to another embodiment of the invention. The authentication method shown in FIG. 4 may be implemented by the authentication system 1 shown in FIG. 1. As shown in FIG. 4, first, the user device 16 logins in the authentication server 12 by a login identification and a password (step S50). After the user device 16 logins in the authentication server 12, a user may operate the user device 16 to input and transmit an operation request to the authentication server 12 (step S52). Then, the authentication server 12 transmits an information downloading request to the storage device 10 according to the operation request (step S54), so as to obtain an information requested by the user device 16 from the storage device 10 (step S56). Then, the authentication server 12 transmits the information to the work server 14 (step S58). For example, if the aforesaid operation request is to encrypt a specific file, the authentication server 12 obtains the specific file from the storage device 10 according to the operation request and then transmits the specific file to the work server 14.

Furthermore, after the user device 16 logins in the authentication server 12 and transmits the operation request to the authentication server 12, the authentication server 12 may attach the operation request to an authentication token and then transmit the authentication token with the operation request to the user device 16 (step S60). Then, the user device 16 transmits the authentication token with the operation request to the work server (step S62) and the work server 14 transmits the authentication token to the authentication server 12 to perform authentication (step S64). Then, the work server 14 obtains an authentication result from the authentication server 12 (step S66). When the authentication result is correct, the work server 14 performs the operation request for the aforesaid information immediately. That is to say, the user does not need to operate the user device 16 to input and transmit the operation request to the work server 14 again. On the other hand, when the authentication result is incorrect, the work server 14 does not perform the operation request for the aforesaid information. It should be noted that the manner of authenticating the authentication token is mentioned in the above and that will not be depicted herein again.

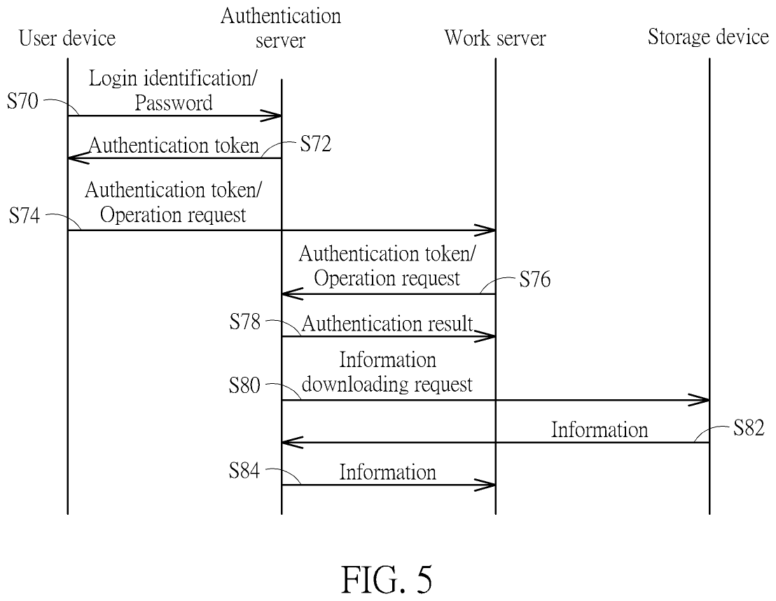

Referring to FIG. 5, FIG. 5 is a time sequence diagram illustrating an authentication method according to another embodiment of the invention. The authentication method shown in FIG. 5 may be implemented by the authentication system 1 shown in FIG. 1. As shown in FIG. 5, first, the user device 16 logins in the authentication server 12 by a login identification and a password (step S70). After the user device 16 logins in the authentication server 12, the user device 16 obtains an authentication token from the authentication server 12 (step S72). After the user device 16 logins in the authentication server 12 and obtains the authentication token from the authentication server 12, the user device 16 may transmit the authentication token and an operation request to the work server 14 (step S74) and the work server 14 transmits the authentication token and the operation request to the authentication server 12 to perform authentication (step S76). For further illustration, in addition to performing authentication for the authentication token, the authentication server 12 may further perform authentication for the operation request. Then, the work server 14 obtains an authentication result from the authentication server 12 (step S78). As mentioned in the above, the authentication server 12 may store a plurality of login identifications of different users and a plurality of access rights correspondingly. When the operation request of the user device 16 does not match with the corresponding access right (i.e. the authentication result of the operation request is incorrect), the authentication server 12 does not transmit the information requested by the operation request to the work server 14. When the operation request of the user device 16 matches with the corresponding access right (i.e. the authentication result of the operation request is correct), the authentication server 12 transmits an information downloading request to the storage device 10 (step S80), so as to obtain an information requested by the user device 16 (step S82). Then, the authentication server 12 transmits the information to the work server (step S84). When the authentication result of the authentication token is correct, the work server 14 performs the operation request for the aforesaid information. On the other hand, when the authentication result of the authentication token is incorrect, the work server 14 does not perform the operation request for the aforesaid information. It should be noted that the manner of authenticating the authentication token is mentioned in the above and that will not be depicted herein again.

As mentioned in the above, the invention performs authentication for the user device through the authentication server with the authentication token and obtains the information requested by the user device from the storage device through the authentication server. When the work server obtains a correct authentication result from the authentication server, the work server performs the operation request of the user device accordingly. On the other hand, when the work server obtains an incorrect authentication result from the authentication server, the work server does not perform the operation request of the user device accordingly. The invention accesses the storage device through the authentication server and the work server does not have access right of the storage device. Accordingly, once the work server is invaded, except the information of the work server, other information of the storage device will not be leaked out.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An authentication system comprising:
a storage device;
an authentication server communicating with the storage device;
a work server communicating with the authentication server; and
a user device communicating with the authentication server and the work server;
wherein the user device logins in the authentication server and obtains an authentication token from the authentication server, the authentication server obtains an information from the storage device and transmits the information to the work server, the user device transmits the authentication token to the authentication server through the work server to perform authentication, the work server obtains an authentication result from the authentication server, and the work server performs an operation request of the user device for the information when the authentication result is correct.

2. The authentication system of claim 1, wherein the authentication server obtains the information from the storage device according to a login identification of the user device.

3. The authentication system of claim 1, wherein after the user device logins in the authentication server, the user device transmits the operation request to the authentication server and the authentication server obtains the information from the storage device according to the operation request.

4. The authentication system of claim 1, wherein after the user device logins in the authentication server, the user device transmits the operation request to the authentication server and the authentication server attaches the operation request to the authentication token.

5. The authentication system of claim 1, wherein the information is a device list or a file.

6. The authentication system of claim 1, wherein after the user device logins in the authentication server and obtains the authentication token from the authentication server, the user device transmits the authentication token and the operation request to the work server, and the work server transmits the authentication token and the operation request to the authentication server to perform authentication.

7. An authentication method comprising:
logining in an authentication server to obtain an authentication token;
obtaining an information from a storage device and transmitting the information to a work server;
transmitting the authentication token to the authentication server through the work server to perform authentication, so as to obtain an authentication result; and
performing an operation request for the information when the authentication result is correct.

8. The authentication method of claim 7, further comprising:
obtaining the information from the storage device through the authentication server according to a login identification.

9. The authentication method of claim 7, further comprising:
after logining in the authentication server, obtaining the information from the storage device through the authentication server according to the operation request.

10. The authentication method of claim 7, further comprising:
after logining in the authentication server, attaching the operation request to the authentication token through the authentication server.

11. The authentication method of claim 7, wherein the information is a device list or a file.

12. The authentication method of claim 7, further comprising:
after obtaining the authentication token, transmitting the authentication token and the operation request to the authentication server through the work server to perform authentication.
